(19) United States
(12) Patent Application Publication
(10) Pub. No.: US 2026/0066666 A1
(43) Pub. Date: Mar. 5, 2026

(54) TRANSIENT FREE SWITCH FOR SOLAR BACKUP POWER SOURCE

(71) Applicant: Teardrop Power LLC, East Grand Rapids, MI (US)

(72) Inventor: David B. Hartung, East Grand Rapids, MI (US)

(21) Appl. No.: 19/306,068

(22) Filed: Aug. 21, 2025

Related U.S. Application Data
(60) Provisional application No. 63/688,367, filed on Aug. 29, 2024.

(51) Int. Cl. H02J 3/38; H02H 7/20

(52) U.S. Cl. CPC H02J 3/381; H02H 7/20; H02J 2101/25

(57) ABSTRACT

A transient free switch includes a first input connected to a first alternating current (AC) power source, a second input connected to a second AC power source, and an output connected to a load. A controller manages a transfer of power using at least one relay and at least one solid-state device. When the relay is in a closed state, the first source is connected to the load. Upon determining a request to switch, the controller switches the relay from the closed state to an open state and switches the solid-state device from a disabled state to an enabled state, which connects the second source to the load. This provides an uninterrupted power path during the relay's mechanical transition. After the relay finishes switching to the open state, the controller switches the solid-state device back to the disabled state.

### CROSS REFERENCE TO RELATED APPLICATION

The present application claims the filing benefits of U.S. provisional application Ser. No. 63/688,367, filed Aug. 29, 2024, which is hereby incorporated herein by reference in its entirety.

### FIELD OF THE INVENTION

The present invention relates generally to a switch and, more particularly, to a solid-state transient free transfer switch.

### BACKGROUND OF THE INVENTION

The use of transfer switches to switch a load between two or more alternating current (AC) power sources is known. For example, Break-Before Make (BBM) devices are transfer switches where a mechanical connection is moved from one contact to another.

### SUMMARY OF THE INVENTION

A transient free switch includes a first input connected to a first alternating current (AC) power source and a second input connected to a second AC power source. The switch includes an output connected to a load. The switch also includes a controller that comprises a processor. The switch includes at least one relay that is mechanically switchable between a closed state and an open state. With the at least one relay in the closed state, the first input is electrically connected to the output via the at least one relay. With the at least one relay in the open state, the second input is electrically connected to the output via the at least one relay. The switch includes at least one solid-state device that is electrically switchable between an enabled state and a disabled state. With the at least one solid-state device in the enabled state, the second input is electrically connected to the output via the at least one solid-state device. With the at least one solid-state device in the disabled state, the second input is not electrically connected to the output via the at least one solid-state device. With the at least one relay in the closed state and the at least one solid-state device in the disabled state, the controller determines a request to electrically connect the second input to the load. The controller, responsive to determining the request, (i) switches the at least one relay from the closed state to the open state and (ii) switches the at least one solid-state device from the disabled state to the enabled state. The controller, after the relay finishes switching from the closed state to the open state, switches the at least one solid-state device from the enabled state to the disabled state.

These and other objects, advantages, purposes and features of the present invention will become apparent upon review of the following specification in conjunction with the drawings.

### BRIEF DESCRIPTION OF THE DRAWINGS

FIG. 1 is a schematic view of a transient free switch with a single relay;

FIG. 2 is a schematic view of a transient free switch with two relays;

FIG. 3 is a schematic view of a controller of a transient free switch;

FIG. 4 is a state diagram for a controller of a transient free switch

FIG. 5 is a schematic view of a transient free switch that includes ground fault and earth ground bonding detection circuitry; and

FIG. 6. is a schematic view of a transient free switch configured for a split-phase application.

### DESCRIPTION OF THE PREFERRED EMBODIMENTS

Historically, the utilization of transfer switches has been integral in managing the distribution of alternating current (AC) power to various loads from multiple AC power sources. The conventional design of these switches predominantly adheres to a “Break-Before-Make” (BBM) configuration. This configuration involves a mechanical action that disconnects the load from one power source before establishing a connection with an alternative source. Such mechanisms, which can be found in both relay-based and manually operated switches, inherently introduce a brief interruption of power supply to the load during the transition period.

Despite their widespread use, BBM transfer switches are not without their limitations. The momentary cessation of power inherent to their operation can be undesirable or even unacceptable in certain scenarios. To address the critical needs of applications where even a transient loss of power can incur repercussions or pose safety risks, an alternative class of transfer switches has been developed, known as “Make-Before-Break” (MBB) devices.

These MBB transfer switches are designed to establish a connection to the subsequent power source prior to disengaging from the current one, thereby ensuring a continuous supply of power throughout the transition. These devices are particularly advantageous in high-stakes environments such as those requiring uninterrupted power or in high-value operations where power disruption can lead to considerable losses. However, the sophistication required for MBB transfer switches to function effectively translates into increased complexity. This complexity is reflected in the higher costs, the intricate assembly of components, and the necessity for the power sources to be synchronized in terms of their AC input. Consequently, while MBB transfer switches offer a solution to the limitations of BBM devices, their implementation is more complex and typically confined to high-power AC applications.

Implementations herein relate to a hybrid solid state transfer switch designed to facilitate an uninterrupted transition of electrical power between sources. The switch is engineered to execute a “Make-At-Break” operation, ensuring that the connected load experiences a seamless and continuous supply of power during the transfer process. The switch includes a combination of electromechanical relays and advanced high voltage solid-state electronic components. These elements are orchestrated to function in unison, governed by a calibrated timing control system. The timing control synchronizes the activation and deactivation of the solid-state devices with the mechanical action of the relay.

During the phase of power transfer, the relay undergoes a switch in its state (i.e., from a closed state to an open state or vice versa). Concurrently, the solid-state devices are engaged to maintain power delivery to the load (i.e., switched from a disabled state to an enabled state). This engagement spans the entirety of the relay's contact transition phase, which includes both the interval when the relay contacts are open and the subsequent contact bounce period. The solid-state devices act as an electrical bridge, providing an alternative pathway for the power to reach the load without interruption. Upon successful completion of the relay's contact closure, the solid-state devices are promptly deactivated. This deactivation is timed to occur precisely when a stable mechanical contact path has been established by the relay. Subsequently, the relay assumes the role of the primary conductor, and electrical power is delivered to the load through this mechanical pathway.

The hybrid design of the switch combines the reliability of mechanical relays with the precision of solid-state technology to provide a robust solution for applications requiring critical power management. The seamless power transfer capability of the invention is particularly advantageous in scenarios where even the briefest power disruption is unacceptable.

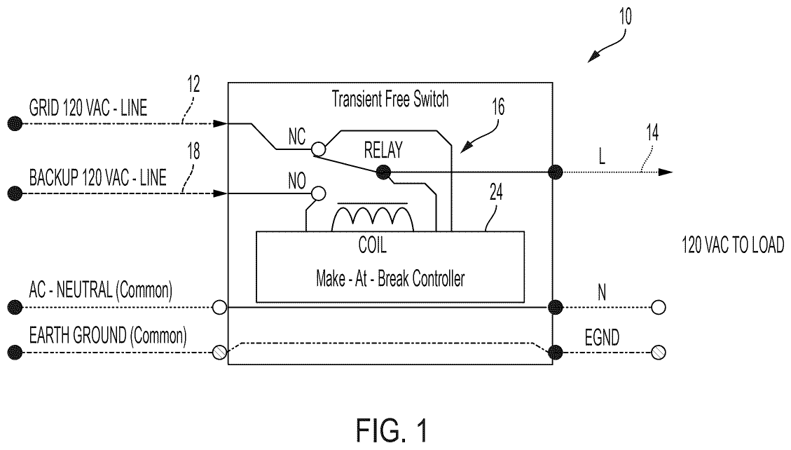

Referring now to FIG. 1, an exemplary transient-free switch 10 (also referred to herein as just the switch 10) is configured to maintain a continuous supply of electricity to a designated load. Under standard operating conditions (i.e., in an unpowered state), the switch is configured to facilitate the direct transmission of electrical power from the grid 12, which may operate at a nominal voltage of 120 VAC, to the load 14 in question. This is achieved through the utilization of a relay mechanism 16 that is set in a Normally Closed (NC) contact position. The relay 16, in its default state (i.e., a closed state), allows for the uninterrupted flow of current from the grid 12 to the load 14, ensuring that the load 14 receives power without the need for any additional activation or power sources. The relay 16, in its open state, allows for the uninterrupted flow of current from the backup power source 18 to the load 14. The relay 16 may be a mechanical relay (i.e., that has a mechanism that physically moves when switching from the closed state to the open state and vice versa).

While FIG. 1 illustrates the switch 10 with a singular relay 16 for the sake of simplicity, the scope of the invention is not limited to the use of a single relay 16. In practice, the switch 10 may incorporate two or more relays 16 to achieve the desired operational performance. The multiplicity of relays is strategically implemented to refine the timing of the contact transition within the mechanical relay components. This precise timing is important, particularly during the phase where there is a need to switch the power source from the grid 12 to an alternative backup source 18.

The transition between power sources is orchestrated to coincide with a specific moment in the AC power cycle, which is referred to as the zero crossing. At this juncture, the voltage waveform passes through a point of zero voltage. The switch 10 leverages solid-state device(s) 24 (e.g., one or more thyristors, one or more transistors, a controller, a processor, etc.). These devices may be activated in half-cycle intervals. The devices 24, during the contact changeover time, temporarily assume the responsibility of providing power to the load 14 (i.e., by switching from a disabled state to an enabled state and then, after the mechanical relay has finished moving, switching from the enabled state to the disabled state). By engaging in this manner, the solid-state devices 24 ensure that there is no interruption in the delivery of power to the load 14, even as the source of electricity is being switched. The precision timing minimizes any potential disturbances or disruptions that could otherwise affect the load during the transition from the grid power source 12 to the backup power source 18.

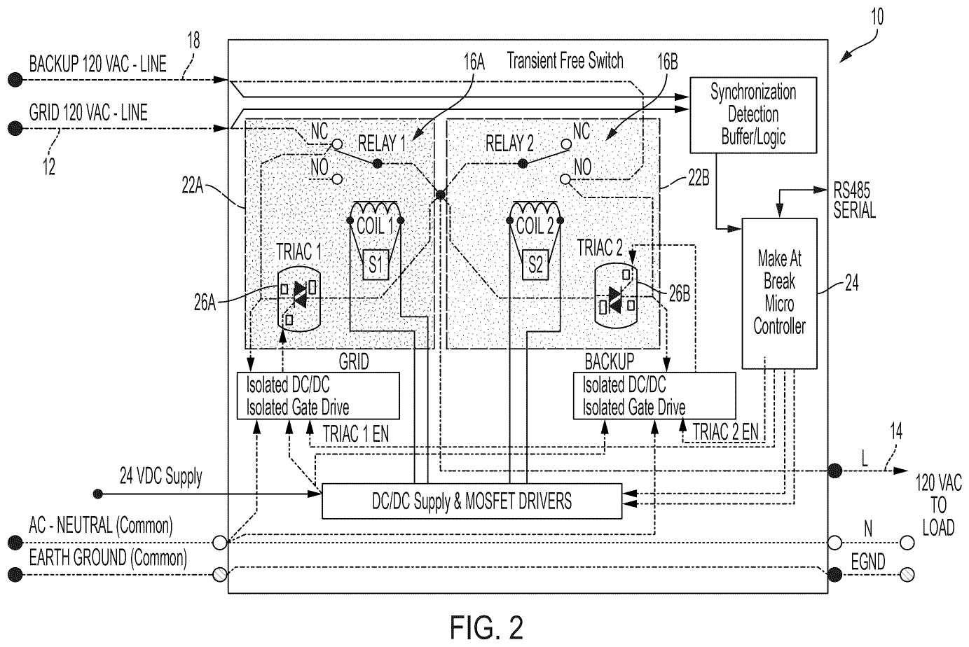

FIG. 2 illustrates another implementation of the switch 10. Here, the switch 10 ensures an uninterrupted power supply to the connected load 14, with devices responsible for the current path of AC power delineated by boxes 22A, 22B. Devices connected to the grid 12 are situated within box 22A, while devices connected to the backup power source 18 are situated within box 22B.

In the unpowered state, the switch 10 provides AC output to the load 14 through the NC contact of a first relay 16A. A second relay 16B remains in a Normally Opened (NO) state during this state. The switch executes a seamless transition between power sources 12, 18 under normal operation, which may be initiated by either a manual request to switch and/or an automatic power command detected by a controller 24.

Upon detecting/determining a request to switch, the controller 24 commences the process of synchronization detection between the two AC sources 12, 18. This involves determining the precise moment when the zero crossing of both sources aligns within a margin of less than a threshold amount of time (e.g., less than 0.2 milliseconds or less than 0.1 milliseconds or less than 0.05 milliseconds). Once the controller 24 determines both the presence of the switch request/command and successful synchronization detection, the controller 24 initiates the switching sequence.

The switching sequence begins with the activation of a first three-terminal AC switch 26A (i.e., TRIAC 1), which ensures the continuation of grid AC output in parallel with the first relay 16A. Subsequently, a coil (i.e., COIL1) of the first relay 16A is deactivated. Following a delay period, which allows for the confirmation of the first relay's 16A open state, a hand-off from TRIAC 1 to a second three-terminal AC switch 26B (i.e., TRIAC 2) is executed. This hand-off is timed. For example, TRIAC 1's gate may be disabled just prior to the falling AC cycle, such as between the 90-degree to 180-degree phase based on the synchronization logic's timing. Then, TRIAC 2's gate drive may be enabled shortly thereafter (e.g., 0.05 milliseconds, 0.1 milliseconds, etc.) after the commencement of the negative going zero crossing, which spans the 180-degree to 270-degree phase. This results in an “OFF” dead time period (e.g., of less than 0.1 millisecond when enabled 0.05 milliseconds after) perfectly correlated to the zero crossing of the synchronous operating AC sources 12, 18.

With the backup power now being provided through TRIAC 2, a coil (i.e., COIL2) of the second relay 16B may be energized. The switch 10 ensures that TRIAC 2 remains active until the closure of the contacts of the second relay 16B is verified and/or after a predetermined delay time. Once this verification is complete, TRIAC 2 is disabled, and power is continuously supplied through the closed contacts of the second relay 16B.

The switch 10 continues to operate from the backup power source 18 until one of several conditions prompts a change. These conditions may include a serial command that requests a switch back to grid power 12, detection of low voltage on a 24 VDC input, or a power and/or circuit/device failure. In the event of low voltage detection, if synchronization is achieved before control power is lost, the system facilitates a transient-free transfer back to the grid. If synchronization is not possible, the design of coil suppression for the first relay 16A and the second relay 16B (i.e., S1 and S2) ensures that COIL2 opens in less than a first threshold period of time (e.g., 10 milliseconds), and COIL1 opens in more than a second threshold period of time (where the second period of time is greater than the first period of time, e.g., 12 milliseconds), allowing for an arc-free transfer back to grid power 12. Additional conditions that may trigger a switch include low backup AC voltage detection or high load current detection while operating on backup AC 18. The switch 10 may include a reset-controlled design to ensure that all TRIACs and relay coil drivers default to an off-state in the event of a failure, with the transfer back to grid power 12 managed by the S1 and S2 suppression control.

The switch 10 may assume that the backup AC power source 18 operates in harmony with the grid power source 12, such as by maintaining a frequency alignment within a margin of plus or minus 0.01% and a voltage congruence within plus or minus 5%. This backup power source 18 may function either in synchronous or asynchronous mode in relation to the grid power source 12. In the case of asynchronous operation, the backup power source 18 and the grid 12 may achieve a natural beat frequency, which is essentially a point of synchronization, typically within a timeframe of less than five minutes under most conditions. This feature is particularly advantageous when the backup power source is utilized in scenarios where “Spare Power Available” is a mode of operation, such as when drawing power from a solar-powered inverter coupled with a battery source. In such instances, a transfer delay spanning several minutes is deemed acceptable and does not pose a significant operational concern.

Furthermore, the switch 10 ensures an immediate transition to the backup AC power source 18 in the event of a grid power 12 outage. While this immediate switch-over is automatic, this scenario may include transients, or brief power losses, during the conversion process. Nevertheless, once the transition to the backup AC power source 18 has been initiated, the switch 10 is capable of sustaining power provision from the backup source 18 for an extended duration, contingent on the continued activity of the backup power supply 18. This seamless integration of the backup power source 18 with the grid 12, along with the automatic transfer capabilities, provides a reliability not readily found in conventional techniques.

Thus, implementations herein are designed to facilitate a seamless transition to a backup power source in a variety of scenarios, such as in a solar power system, including maximum power point tracking (MPPT), batteries, and inverters, with an objective of enhancing the utilization of renewable energy and reducing reliance on grid-supplied alternating current (AC) power. Maximum power point tracking is applicable to a solar charger/controller that converts widely varied DC voltage and current from a solar panel to battery storage energy using a current mode of control that harvests the maximum amount of solar energy available at a point in time. The switch may operate within an environment where the solar power setup is responsible for generating and storing energy within a battery. Under normal circumstances, when the battery approaches full capacity, any excess energy produced by the solar panels would be rendered unusable due to the absence of a corresponding load. Implementations herein address this inefficiency through the implementation of a transient free switching (TFS). For example, as the MPPT begins to decrease the charging current to the battery to prevent overcharging, the TFS activates, thereby redirecting the solar energy to power the load directly.

A power system controller may monitor the state of charge of the battery and may be programmed to determine the balance between the amount of battery power reserved for potential grid outages and the amount allocated to supplant grid power, thereby optimizing the use of solar energy. This balance can be dynamically adjusted by the controller, which may take into account various factors such as weather conditions or specific user or system commands, to modify the proportion of energy reserved for backup purposes.

In scenarios where the switch 10 is integrated with a smart grid, the TFS becomes a critical element for the grid operator to execute controlled reductions in grid load, a process known as commanded de-loading. The switch 10 is capable of providing feedback to the smart grid regarding the available backup power from the battery and the estimated duration of power availability. This feedback is essential to ensure a smooth transition between the backup power source and the grid supply, thereby maintaining uninterrupted operation for the user. The switch 10 provides intelligent management of energy sources to enhance the efficiency and reliability of power supply systems, particularly in the context of renewable energy solutions.

The switch 10 may integrate a pair of relays and TRIACs to facilitate a controlled time delay. This delay may be strategically orchestrated to occur between the disengagement of one relay and the engagement of the other relay's contacts. Within this period of time, an assessment of the electrical parameters is conducted. This includes, for example, the monitoring of voltage and current across various services, such as the grid and backup power sources, as well as the output load. An aspect of this monitoring is the verification of the relay contact position, which determines whether the contacts are conducting, open, or closed.

The switch 10 is equipped with a controller 24 (e.g., a processor, microprocessor, a field programmable gate array, etc.) that utilizes the feedback from the current and voltage sensing to perform fault detection. This proactive approach ensures a safe response in the event of any discrepancies. The controller 24 is designed to initiate a fail-safe mechanism and provide clear indications of failure, thereby mitigating the risk of latent faults that could otherwise lead to an interruption in power supply to the load. The detection capabilities of the switch 10 encompass a range of potential issues. These include, but are not limited to, the incorrect switching of the relays, anomalies in the normal conduction paths, and faults associated with the return (neutral) or ground. The switch 10 is capable of identifying scenarios where the return current deviates from its intended path through the neutral wire.

Moreover, the current sensing extends the functionality of the switch 10 to include net power metering. This feature provides forward power use estimates, which in turn contribute to a more informed system-level analysis. Such analysis assists in determining the energy storage capacity and estimating the time remaining before the energy reserves are depleted. This approach to monitoring and control not only enhances the reliability of the power supply but also supports efficient energy management.

In some implementations, the switch 10 integrates a single relay with a dual semiconductor configuration to reduce costs. This design is characterized by a precise timing mechanism, which coordinates the movement of the contact in relation to the synchronous alternating current (AC) power's zero crossing point. The objective is to achieve a relay state where the contact is in transition-neither in the normally closed (NC) nor in the normally open (NO) position-but rather, ideally positioned at the zero crossing point.

In this configuration, a single silicon-controlled rectifier (SCR) or TRIAC, which operates on half-wave conduction, may be activated to initiate conduction from the AC line source. This activation occurs prior to the contact's movement. As the AC power reaches the zero crossing point, and while the contact remains in the ‘open’ state, the switch to the AC line is engaged. This engagement allows for the conduction of one or more half-wave cycles, effectively supplying power to the load during the interim period until the relay contact reaches and settles in its closed position.

A notable advantage of this topology is its inherent fault tolerance, particularly in scenarios where there is a loss of control power. In such cases, the relay will naturally de-energize and revert to the NC contact position. This transition occurs smoothly, without the generation of arcs or transient connections between the two AC sources. There may be a transient loss of power to the load, typically ranging from 6 to 15 milliseconds, as a consequence to this approach.

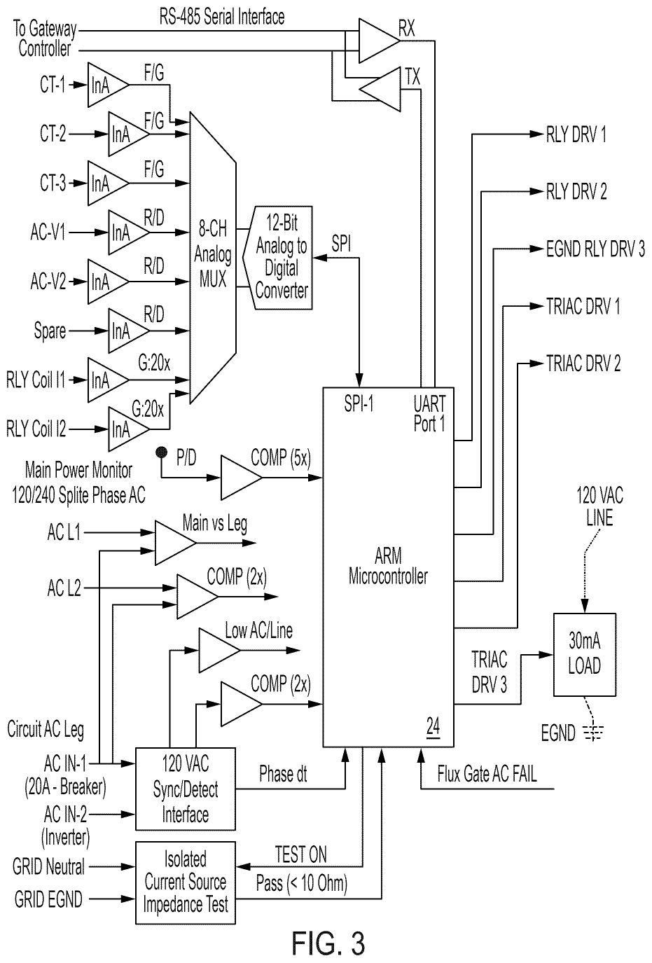

Referring now to FIG. 3, the controller 24 (e.g., an ARM microcontroller) is optionally equipped with a series of analog inputs and control outputs to facilitate monitoring and control of power systems. The microcontroller interfaces with one or more current transformer (CT) inputs, (CT-1, CT-2, and CT-3 as shown in FIG. 3). These inputs are responsible for monitoring the AC at the points AC IN-1, AC IN-2, and the differential between the AC line and neutral leading to the output load. Instrumentation amplifiers associated with these inputs are tasked with the functions of, for example, filtering, amplifying, and offsetting the signals to ensure they remain within the permissible input range of an analog to digital converter. Additionally, each CT input may be under the surveillance of peak and loss detection comparators (P/D), which are designed to identify and respond to conditions of over-current and under-current.

To ensure ground fault failures are mitigated in both on-grid and off-grid applications, the controller 24 also interfaces with specialized circuits. As shown in FIG. 3, these may include a flux gate interface for receiving ground fault and test verification signals. The controller 24 may receive input from a Grid AC Neutral to Earth ground bonding test circuit, such as an isolated current source impedance test block. To manage these functions, the controller 24 generates control signals, which may include a ground bonding relay drive signal (e.g., EGND RLY DRV 3) to control the ground bonding relay 27, and a separate drive signal (e.g., TRIAC DRV 3) used to activate a test load for short-duration AC line fault injection.

The system may also include analog inputs (i.e., AC-V1 and AC-V2) dedicated to the voltage monitoring of AC IN-1 and AC IN-2, respectively. By measuring both current and voltage, the ARM microcontroller may determine the true root mean square (RMS) power for grid and inverter power monitoring as well as metering functions. Optionally, analog inputs for the relay coils (i.e., RLY Coil 11 and RLY Coil 12) monitor the current flowing through the AC power switching relay coils. This monitoring provides feedback regarding any built-in test and confirms the status of the relay contacts'intended position. A main power monitor of the switch uses inputs AC L1 and AC L2 to monitor the presence of split phase power. This may be achieved through the use of line drop threshold comparators, which are tuned to detect optimal line loss at a level set to a threshold percentage (e.g., 80%) of the expected nominal AC line voltage.

Optionally, the switch includes circuitry designed to sample the AC IN-1 and AC IN-2 lines in two separate circuits. Low AC/Line comparators may be employed to detect any low voltage conditions, and their outputs may be processed as interrupts by the controller 24. In the event that both the main power monitor and the AC leg monitor concurrently signal a loss of grid power, the switch is activated to immediately transition to inverter/backup power, thereby ensuring uninterrupted power supply to the load. Conversely, if the main power monitor indicates the presence of power across both split phase legs, but the AC IN-1 line is devoid of AC power, the controller 24 may respond by issuing a warning to the user through a gateway or other interface. This warning signifies the detection of an open condition in the AC IN-1 line, which may be associated with, for example, a 20A breaker. Upon receiving this notification, the user may be prompted to intervene and facilitate the transfer of power to AC IN-2.

The switch may include a 120 VAC (or other voltage) Sync/Detection Interface that samples the alternating current inputs in a manner that yields a waveform closely resembling a square wave. This may be achieved through a summing circuit, which is alternatively referred to as a difference circuit, that processes the inputs to produce a singular output signal. This signal is indicative of the temporal disparity, or phase difference, between the two power sources. The system may monitor this time difference and, when it falls below a predetermined delta time threshold, a relay or TRIAC switching circuit is engaged. This circuit may be governed by the controller 24.

The switch is responsive to the availability of backup power (e.g., solar power) contingent upon user-defined parameters. When the system determines that the backup power is in phase with the grid and meets the user's criteria, the controller 24 may initiate the transfer of the electrical load to the backup power. Conversely, in scenarios where backup power is deemed insufficient, such as during periods of low solar output that necessitate battery backup, and synchronization with the grid is confirmed, the controller 24 may facilitate the reversion of the load back to primary power (e.g., the grid).

In instances where a main power/grid power outage is detected (which may be indicated by the main power monitor registering below the acceptable threshold), the controller 24 may conduct a verification process to ensure that the current directed towards the load is minimal. Following this confirmation, the controller 24 may promptly transition the power supply to the backup power source. The backup power is then utilized to sustain the load until the backup power becomes low on power (e.g., a gateway communicates a low battery state). Upon receiving this notification, the switch may be set to an open state, effectively disconnecting both the grid and the backup power sources from the load. This precautionary measure serves to shield the load from potential damage that could arise during periods of low line voltage or transient power line disturbances.

Throughout the various operational states of the switch, a dedicated battery backup, exemplified here as a 24 VDC power source, ensures that any gateway and the switch remain functional. This backup supports the continuous relay of warnings, status updates, and statistical data regarding the power system to the user, increasing the overall reliability and user awareness of the system's performance.

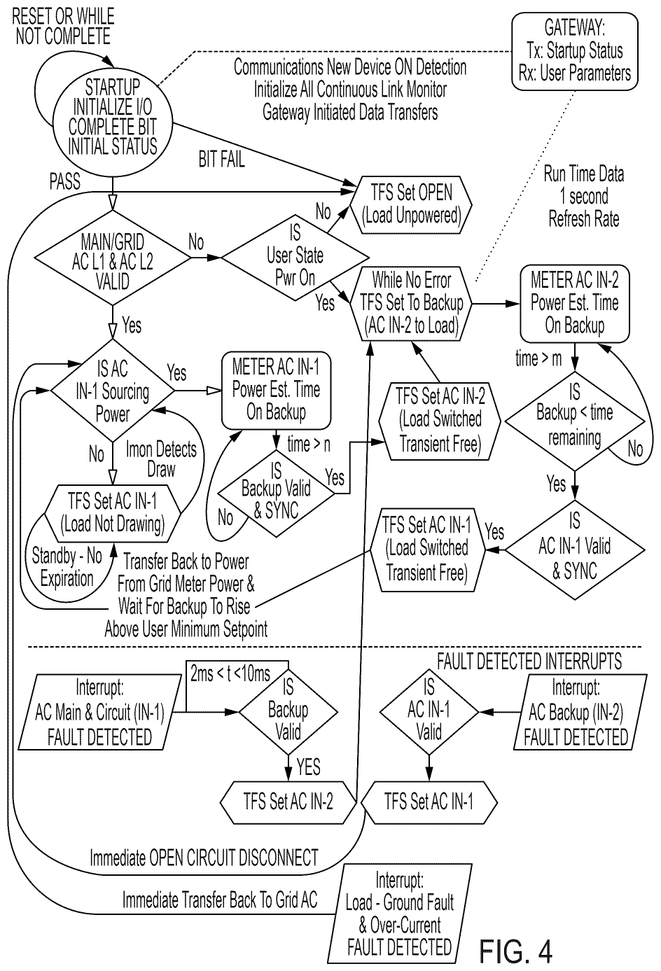

FIG. 4 illustrates an exemplary state machine for the controller 24. In this example, the controller 24 is in communication with a gateway. The gateway may be a communication gateway that is responsible for collecting information regarding the status and performance of the power system (e.g., a solar power system). The gateway may provide one or more interfaces for communicating with a user of the system (e.g., via a display or communications to one or more user devices of the user) regarding the status and performance of the system.

Thus, implementations herein include a transient free switch or system or hybrid solid-state transfer switch or system that provides a Make-At-Break operation of power selection whereby the load is provided with virtually no loss of power. The switch manages multiple asynchronous AC power source inputs (i.e., two or more AC power source inputs), facilitating the selection of one source to provide output power to a load in a seamless transition in a Make-At-Break arrangement. This switch or system allows for a user-configurable priority-driven selection, enabling the user to prioritize the power sources based on preference and the availability of backup energy sources that are not reliant on the grid. The system is adept at supporting renewable energy sources by prioritizing these sources and selecting the most efficient source for the given load, ensuring that the available energy is used both efficiently and completely.

A feature of the system is the ability to enable glitch-less transfer switching of power. This ensures that there is a minimal drop in current delivered to the load during the transfer, with a period of time less than, for example, 0.150 milliseconds, which is generally imperceptible to both the load and the user. The switch, in conjunction with a system controller, intelligently determines when solar energy production exceeds the battery's charging needs-such as when the battery is nearly full and the MPPT charge controller reduces the current. At this juncture, any excess solar energy, which would otherwise be wasted, is redirected to power an existing AC load, thereby maximizing the utilization of resources and converting captured energy into a value-added need, such as offsetting grid power consumption.

The system also prioritizes load selection based on historical and present load demands, taking into account the current and voltage (such as the current multiplied by the voltage). The system performs calculations for the duration of backup power, accumulated power metering, and issues warnings and general status updates through a user interface. The design includes functionality to handle typical grid failures, automatically switching to backup energy sources. This is achieved through a controller (e.g., a microcontroller) that detects a grid failure within, for example, 3 milliseconds or less and promptly switches to backup inverter power. The switch may be based on the detection of a loss of current at multiple monitoring points, with an immediate transfer of power to the backup AC source using one or more TRIACs and relays.

The switch may support a 20-amp single-phase 120 VAC 60 Hz power source for household circuits, such as those used for kitchen refrigerators. However, the switch is not inherently limited to this specific voltage, frequency, or current rating, but may instead support any number of voltages, frequencies, and current ratings. The components of the switch may be scaled to accommodate larger or smaller currents, as well as variations in voltage and frequency, including multiple phase power circuits.

The switch incorporates a circuit for AC zero crossing detection for each input for timing, synchronization, determination, and power factor calculation. For safety, the system ensures that in the event of a complete power loss at the backup, backup failure, or any event leading to a reset and loss of backup control, there is an analog fallback to grid power. This prevents any shorting of power, damage, or loss of function within the switch, ensuring that if grid power is available, the load will continue to operate without interruption.

Furthermore, power transfer at the switch is fault-protected and hysteresis-protected to prevent oscillation between sources, thus providing a clean transfer in both directions-whether switching to grid power when on backup power or vice versa. The switch also includes current and voltage monitoring using analog circuits, current transformers, and discrete signals. This monitoring system provides overcurrent and ground fault current trip/fail-safe mechanisms, along with indications of faults and transfers.

The system utilizes isolated DC/DC power converter technology for floating gate supply (i.e., the high side TRIAC drive of the AC line output). The form factor of the switch may be a module that can be added to a standard household circuit breaker panel. For example, the panel's 20A circuit breaker output may be fed to the input of the switch (AC Source 1), while a second AC source is similarly fed to the switch (AC Source 2, Inverter/backup), with the AC output of the module wired to the load that was previously connected within the household panel at the 20A breaker.

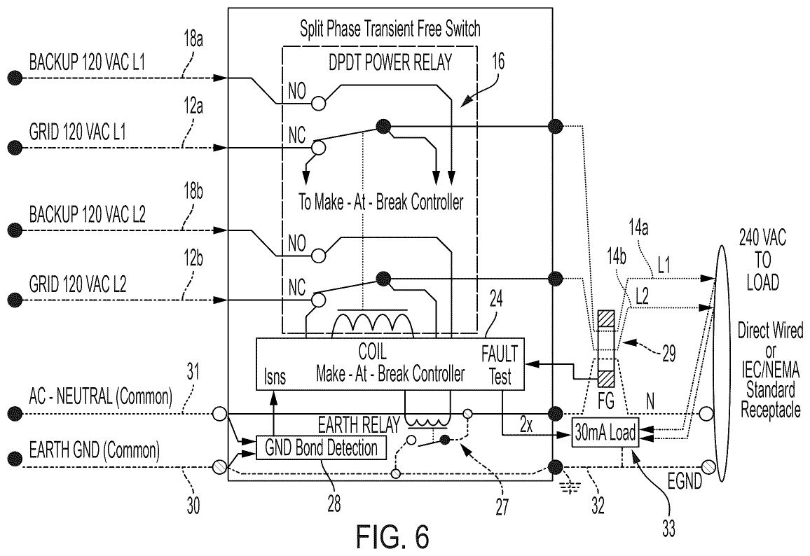

In some examples, the system can be embodied in a form factor resembling a standard household circuit breaker with three terminals: two that are physically similar to the grid AC source and the wire connection to the load (circuit breaker output), plus an additional terminal that accommodates the backup AC power input. This form factor effectively serves as a replacement circuit breaker for existing household panels. While examples herein have detailed a single-phase application, the Make-At-Break (TFS) may be modified for use in split-phase and three-phase AC power systems by incorporating dual pole and three-pole relays, and a corresponding number of TRIAC components per pole, respectively. For example, and as discussed in more detail below, FIG. 6 illustrates a split-phase 240 VAC implementation. The system provides comprehensive test, fault management, and power source selection control using a controller (e.g., an embedded ARM processor).

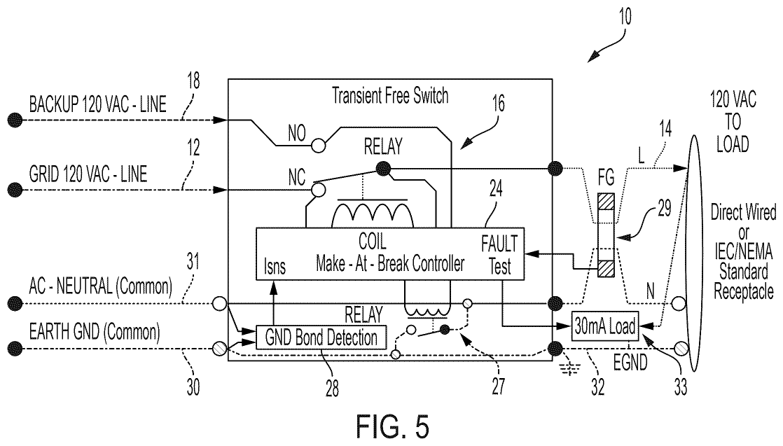

Referring now to FIG. 5, an implementation is shown that provides for safe ground fault operation of the hybrid solid-state transient free switch 10. In a system that may include an on-grid connection in some cases, but also may not include a grid-connection in other cases, such as for a recreational vehicle (RV), it is required to both determine the state of the earth ground return bonding and to provide a means to make or break the bonding to meet electrical code requirements and maintain the functional integrity of ground fault protection. For example, a grid-connected RV that includes a solar/battery/inverter AC generation component feeding the switch 10 (Solar AC) together with a second AC power input (GRID AC) requires a single Neutral to Earth ground bonding provided at the Grid Source (typically the main service/breaker panel), and the RV maintaining a not-connected Chassis (RV Frame) bonding between Neutral and Chassis. Ground fault mitigation is then provided per the electrical code at a single point within the service/breaker panel. However, when the GRID AC connection is removed (e.g., when the RV is in a remote, off-grid application), the missing Frame to Neutral bonding functionally disables ground fault protection in the event of a potential failure from a connected load. FIG. 5 shows a redundant fault-feedback means for automatically detecting the missing ground bond, and for mitigating it by enabling a ground bonding relay 27, thereby ensuring proper ground fault operation in both grid-connected and off-grid-connected applications.

In one implementation, the controller 24 receives a potential Grid AC input ground bond failure via a signal (e.g., signal Isns) from an open circuit test circuit 28 (i.e., GND bond detection circuit). The open circuit test circuit 28 may be an isolated low voltage current source with a threshold impedance, such as a 10-ohm maximum impedance test threshold. If the Grid AC input signals an absent voltage and the open circuit detector circuit 28 signals “open”, then the ground bonding relay 27 makes the connection between Neutral and Chassis (EGND) as shown.

The controller 24 re-tests the ground bonding between Chassis and EGND via circuit 28 and proceeds with a second test upon passing. With ground bond relay 27 closed, and verification per the test of circuit 28, and while AC output is provided to the load via the backup power source 18, the controller 24 verifies ground fault detection by temporarily overriding the ground fault signal (FAULT) provided by a flux gate detector 29, and then injects a ground fault through a controlled impedance AC load, such as a 30 mA AC load 33. Implemented in this order, the chassis voltage does not present a potentially harmful condition but provides a positive verification of ground fault detection as the “FAULT” signal is observed at the controller 24. The controller 24 maintains AC output through this short-term induced ground fault condition (e.g., for 30 milliseconds), then removes the fault current and returns to normal ground fault operation, i.e., shut-down of AC output upon a ‘FAULT’signal being detected by the flux gate detector 29.

Referring now to FIG. 6, an implementation of the switch 10 is shown that is configured for a split-phase application, such as a 240 VAC application. This implementation includes several provisions in contrast to the single-phase designs previously detailed.

This implementation utilizes a double-pole relay, whereby a first leg (L1) and a second leg (L2) are switched simultaneously under the control of the controller 24. This simultaneous switching selects either a split-phase backup power source (e.g., connecting backup source terminals 18a and 18b to load terminals 14a and 14b, respectively) or a split-phase grid power source (e.g., connecting grid source terminals 12a and 12b to load terminals 14a and 14b, respectively).

Although not explicitly shown in FIG. 6 for clarity, solid-state switching devices, such as the TRIACs described with reference to FIG. 2, are incorporated for each of the L1 and L2 paths. This configuration supports the transient-free operation as detailed herein.

Furthermore, the implementation in FIG. 6 includes earth ground to chassis ground bonding detection and flux gate ground fault feedback, operating in a manner similar to the system described with reference to FIG. 5. However, in this split-phase configuration, the verification processes are expanded to test each of the L1 and L2 AC output paths individually after a localized bonding of the chassis to earth ground (EGND) has been established.

Thus, implementations herein include a hybrid solid-state transient free transfer switch or system for switching a load between two or more AC power sources, such as a grid and a backup source. The switch utilizes a combination of electromechanical relays and solid-state devices, such as TRIACs, to ensure a continuous and seamless supply of power to the load during the transition between power sources. The switch is controlled by a controller that detects the synchronization of the AC sources, the zero crossing of the AC waveform, and the relay contact position, and initiates the switching sequence accordingly. The switch is particularly advantageous for applications that require uninterrupted power or that use renewable energy sources, such as solar power, to supplement or replace grid power.

Changes and modifications in the specifically described embodiments can be carried out without departing from the principles of the invention, which is intended to be limited only by the scope of the appended claims, as interpreted according to the principles of patent law including the doctrine of equivalents.

1. A transient free switch, the switch comprising:
a first input connected to a first alternating current (AC) power source;
a second input connected to a second AC power source;
an output connected to a load;
a controller that comprises a processor;
at least one relay that is mechanically switchable between a closed state and an open state, wherein, with the at least one relay in the closed state, the first input is electrically connected to the output via the at least one relay, and wherein, with the at least one relay in the open state, the second input is electrically connected to the output via the at least one relay;
at least one solid-state device that is electrically switchable between an enabled state and a disabled state, wherein, with the at least one solid-state device in the enabled state, the second input is electrically connected to the output via the at least one solid-state device, and wherein, with the at least one solid-state device in the disabled state, the second input is not electrically connected to the output via the at least one solid-state device;
wherein, with the at least one relay in the closed state and the at least one solid-state device in the disabled state, the controller determines a request to electrically connect the second input to the load;
wherein the controller, responsive to determining the request, (i) switches the at least one relay from the closed state to the open state and (ii) switches the at least one solid-state device from the disabled state to the enabled state; and
wherein the controller, after the relay finishes switching from the closed state to the open state, switches the at least one solid-state device from the enabled state to the disabled state.

2. The transient free switch of claim 1, wherein the first AC power source comprises a grid AC power source, and wherein the second AC power source comprises a backup AC power source.

3. The transient free switch of claim 1, wherein the at least one relay consists of a single relay.

4. The transient free switch of claim 1, wherein the at least one relay comprises two relays.

5. The transient free switch of claim 1, wherein the at least one solid-state device comprises a thyristor.

6. The transient free switch of claim 5, wherein the thyristor comprises a triode for alternating current (TRIAC).

7. The transient free switch of claim 1, wherein the controller switches the at least one relay from the closed state to the open state based on determining when both the first input and the second input are at zero volts within a threshold period of time.

8. The transient free switch of claim 7, wherein the threshold period of time is less than 0.1 milliseconds.

9. The transient free switch of claim 1, further comprising a third input connected to a direct current (DC) power source, and wherein the controller, while the at least one relay is in the open state and responsive to determining a low voltage on the third input, switches the at least one relay from the open state to the closed state.

10. The transient free switch of claim 1, wherein the controller, while the at least one relay is in the open state and responsive to determining a power failure on the second input, switches the at least one relay from the open state to the closed state.

11. The transient free switch of claim 1, wherein the controller, while the at least one relay is in the open state, switches the at least one relay from the open state to the closed state based on a current provided to the load.

12. The transient free switch of claim 1, wherein the request is based on prioritizing a renewable power source.

13. The transient free switch of claim 12, wherein the renewable power source is solar power.

14. The transient free switch of claim 1, further comprising:
a ground fault detector configured to generate a fault signal;
a ground bonding relay configured to selectively create a bond between a neutral line and an earth ground;
an open circuit test circuit configured to test for a pre-existing bond between the neutral line and the earth ground; and
wherein the controller, based on a signal from the open circuit test circuit, controls the ground bonding relay.

15. The transient free switch of claim 14, wherein the controller:
determines, based on the signal from the open circuit test circuit, an absence of the pre-existing bond; and
in response to determining the absence of the pre-existing bond, activates the ground bonding relay to create the bond.

16. The transient free switch of claim 15, further comprising a test load circuit, wherein the controller, after the bond is created by the ground bonding relay, verifies operation of the ground fault detector by:
activating the test load circuit to inject a fault current; and
monitoring the ground fault detector for the fault signal in response to the injected fault current.

17. A transient free switch, the switch comprising:
a first input connected to a grid AC alternating current (AC) power source;
a second input connected to a backup AC power source;
an output connected to a load;
a controller that comprises a processor;
at least one relay that is mechanically switchable between a closed state and an open state, wherein, with the at least one relay in the closed state, the first input is electrically connected to the output via the at least one relay, and wherein, with the at least one relay in the open state, the second input is electrically connected to the output via the at least one relay;
at least one solid-state device that is electrically switchable between an enabled state and a disabled state, wherein, with the at least one solid-state device in the enabled state, the second input is electrically connected to the output via the at least one solid-state device, and wherein, with the at least one solid-state device in the disabled state, the second input is not electrically connected to the output via the at least one solid-state device;
wherein, with the at least one relay in the closed state and the at least one solid-state device in the disabled state, the controller determines a request to prioritize a renewable power source by electrically connecting the second input to the load;
wherein the controller, responsive to determining the request, (i) switches the at least one relay from the closed state to the open state and (ii) switches the at least one solid-state device from the disabled state to the enabled state; and
wherein the controller, after the relay finishes switching from the closed state to the open state, switches the at least one solid-state device from the enabled state to the disabled state.

18. The transient free switch of claim 17, wherein the at least one relay consists of a single relay.

19. The transient free switch of claim 17, wherein the at least one relay comprises two relays.

20. A transient free switch, the switch comprising:
a first input connected to a first alternating current (AC) power source;
a second input connected to a second AC power source;
an output connected to a load;
a controller that comprises a processor;
at least one relay that is mechanically switchable between a closed state and an open state, wherein, with the at least one relay in the closed state, the first input is electrically connected to the output via the at least one relay, and wherein, with the at least one relay in the open state, the second input is electrically connected to the output via the at least one relay;
at least one solid-state device that is electrically switchable between an enabled state and a disabled state, wherein, with the at least one solid-state device in the enabled state, the second input is electrically connected to the output via the at least one solid-state device, and wherein, with the at least one solid-state device in the disabled state, the second input is not electrically connected to the output via the at least one solid-state device;
wherein, with the at least one relay in the closed state and the at least one solid-state device in the disabled state, the controller determines a request to electrically connect the second input to the load;
wherein the controller, responsive to determining the request, (i) switches the at least one relay from the closed state to the open state and (ii) switches the at least one solid-state device from the disabled state to the enabled state;
wherein the controller switches the at least one relay from the closed state to the open state based on determining when both the first input and the second input are at zero volts within a threshold period of time
wherein the controller, after the relay finishes switching from the closed state to the open state, switches the at least one solid-state device from the enabled state to the disabled state; and
wherein the controller, while the at least one relay is in the open state and responsive to determining a power failure on the second input, switches the at least one relay from the open state to the closed state.

21. The transient free switch of claim 20, wherein the at least one solid-state device comprises a thyristor.

22. The transient free switch of claim 21, wherein the thyristor comprises a triode for alternating current (TRIAC).
